(19) United States
(12) Patent Application Publication
(10) Pub. No.: US 2015/0309064 A1
(43) Pub. Date: Oct. 29, 2015

(54) DEVICE FOR AUTOMATIC SAMPLING

(71) Applicant: GERSTEL Systemtechnik GmbH & Co. KG, Mulheim (DE)

(72) Inventor: Bernhard Rose, Dusseldorf (DE)

(21) Appl. No.: 14/664,537

(22) Filed: Mar. 20, 2015

(30) Foreign Application Priority Data
Mar. 28, 2014 (DE) 10 2014 004 578.1

(51) Int. Cl. G01N 35/10; B01L 3/02

(52) U.S. Cl. CPC G01N 35/10; B01L 3/0217

(57) ABSTRACT

Device for automatic sampling of samples for sample preparation or sample introduction for an analytical apparatus, in particular a chromatograph, with a movable holding arm for exchangeably holding at least one sampler, and with sample containers, from each of which a sample can be taken by means of a sampler that can be moved up and down, wherein, for taking up a sample of granular material, the sampler comprises a cannula as a filling space, in which a cannula plunger is displaceably arranged for opening and emptying the filling space of the cannula that is to be filled with a sample, and the cannula comprises a free lower end which, in order to introduce granular material into the filling space of the cannula, is repeatedly pushed against the bottom of the respective sample container, containing a quantity of granular material, using a predetermined pressure, which can be set by means of a pressure limiter associated with the sampler or with the sample container.

The invention relates to a device for automatic sampling of samples for sample preparation or sample introduction for an analytical apparatus according to the preamble of claim 1.

Analytical apparatuses are used for the qualitative and quantitative determination of the constituents of samples, in particular using chromatographic separation methods. The efficiency of the separating techniques can generally be enhanced by suitable sample preparation or sample introduction. The user achieves a maximum level of precision, reproducibility and sample throughput only if he succeeds in automating the sampling procedure. For chromatographs, in particular gas chromatographs, automated sample preparation and sample injection devices are thus known, which are called autosamplers.

DE 102 19 790 C1 discloses such an autosampler, which comprises a holding arm for a holder of a sampler, said holding arm being movable in three directions perpendicular to one another. Autosamplers of this kind are designed for a predetermined, simple sequence, for example sampling by means of a syringe from an ampoule (vial) and introduction of the sample in a sample introduction system of an analytical apparatus, and for a type of sampler proposed for this sequence, for example syringes of a specific size. It is therefore also known to provide several holders for a holding arm.

However, the syringes used permit only the sampling of liquids or gases. In the case of solids, at least the analysis steps of weighing in samples and dissolving the samples are additionally required. Non-granular solid materials also have to be ground. Robot systems, which take over the operations normally performed manually by a laboratory chemist, therefore require at least four degrees of freedom of movement to be able to serve all positions within a circle of movement. The sampling of solid materials is therefore complicated and is not possible with the known autosamplers.

The object of the invention is therefore to provide a device for automatic sampling that improves the automated handling of samples from granular materials for analysis.

This object is achieved by the features of claim 1.

Hereby, a device for automatic sampling is provided which allows the sampling of granular materials to be integrated into the system for sampling of liquid and gaseous samples, such that, with the known devices for automatic sampling, in particular autosamplers, it is also possible to automate the sampling of granular materials. The syringes used for sampling in such autosamplers have syringe needles which, according to the invention, are designed as cannulas with integrated cannula plungers. Samplers with such cannulas can be handled using movable holding arms of autosamplers. The pressure limiter provided according to the invention is a supplementary module to autosamplers, without the operational setup of the latter being modified.

The cannulas according to the invention can define filling spaces via the positioning of the cannula plunger in the cannula, which filling spaces take up defined dose quantities, such that the effort of weighing-in can be reduced. Granular material in minimal quantities can easily be weighed in according to the invention, in particular by a controlled downward movement of the cannula plunger.

For simple retrofitting of existing autosamplers, the trays with a number of sample containers can comprise socket insets with spring elements for a spring-loaded support of the sample containers. A movement of the sample container relative to the sampler is controlled, such that pressing forces of the lower end of the cannula against the bottom of the sample container during introduction of a sample into the filling space of the cannula can be adjusted and limited.

The sampling from a sample container according to the invention can be used, for example, in sample preparation, for introduction into a vial closed with a septum, or for sample introduction in the injection process.

Further embodiments and advantages of the invention are set forth in the following description and in the dependent claims.

The invention is explained in more detail below on the basis of the embodiments shown in the attached figures.

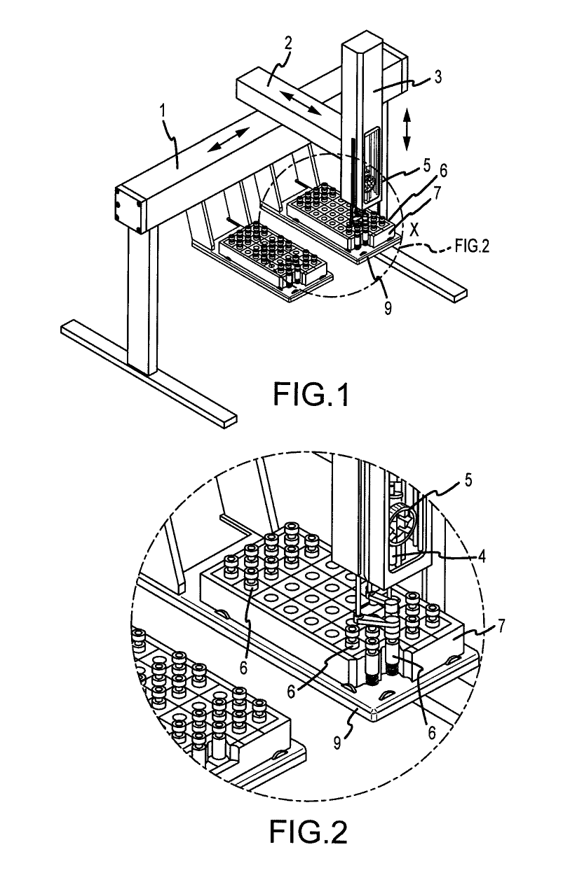

FIG. 1 shows schematically a plan view of a device for automatic sampling of samples according to a first embodiment,

FIG. 2 shows the detail X from FIG. 1 in an enlarged view,

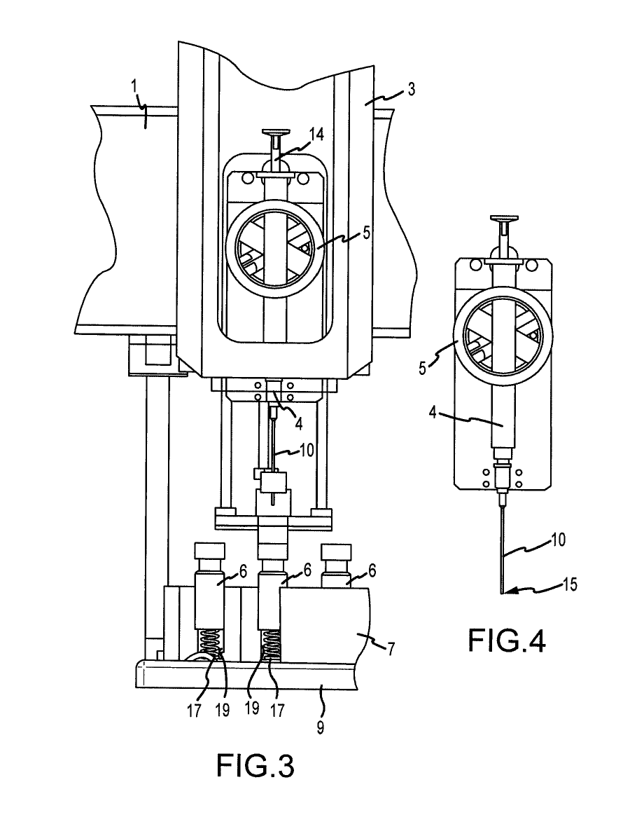

FIG. 3 shows a front view of the sampler held on a movable holding arm and with a sample tray for sample containers according to FIG. 1,

FIG. 4 shows a front view of the sampler according to FIG. 3,

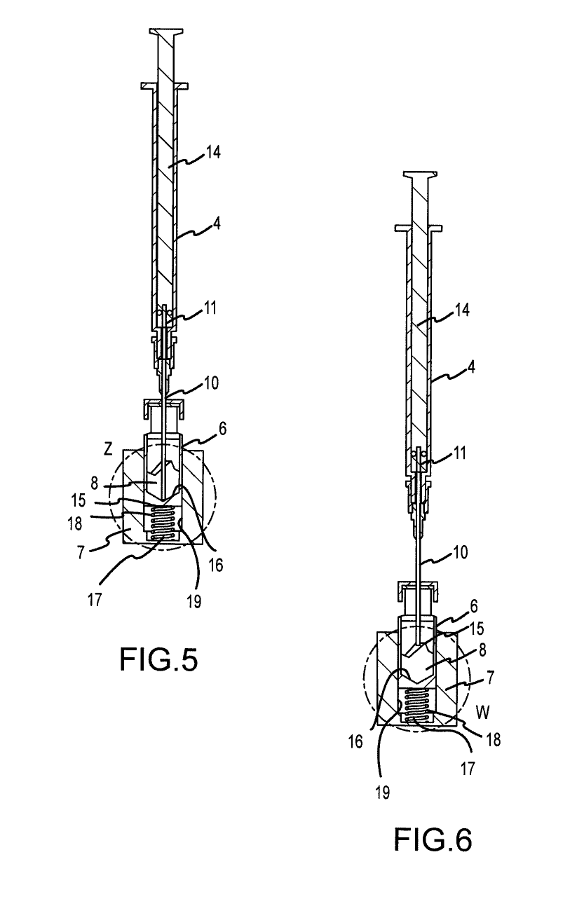

FIG. 5 and FIG. 6 show, in cross section, the operation of a cannula according to the invention in a sampling procedure,

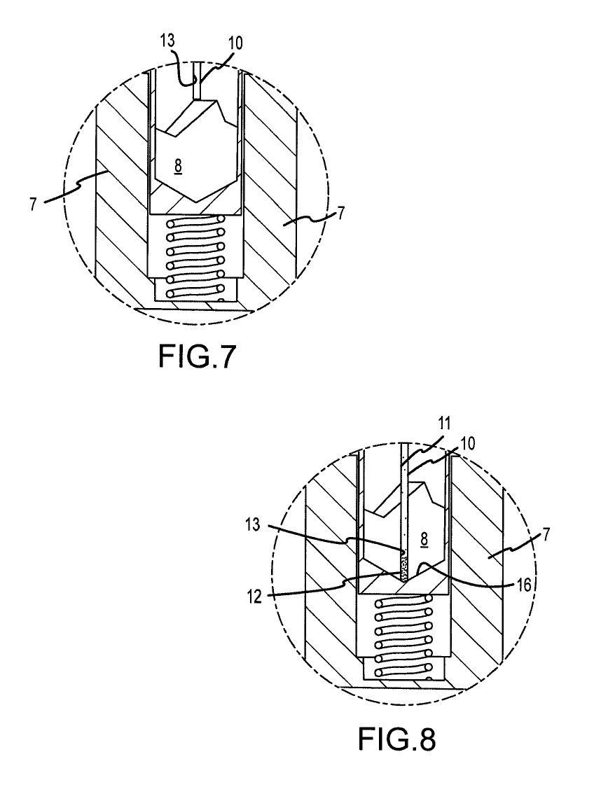

FIG. 7 shows the detail W from FIG. 6 in an enlarged view,

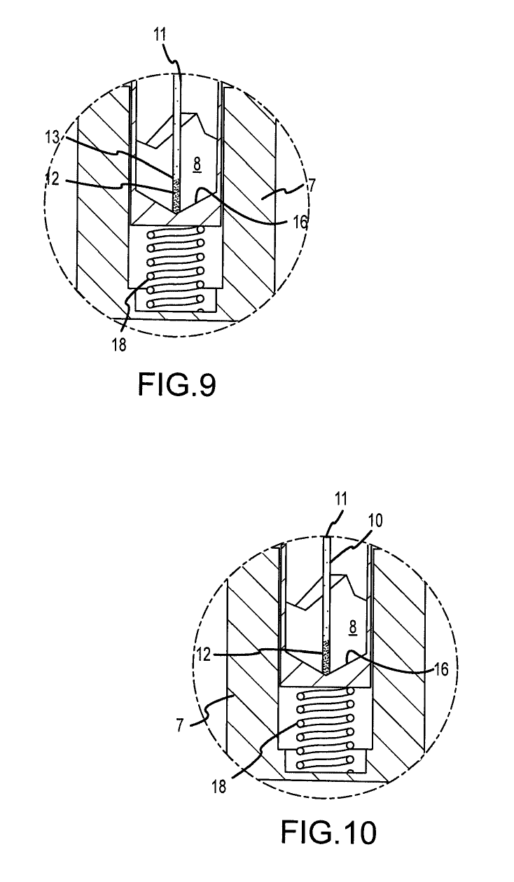

FIG. 8 to FIG. 10 show the detail Z from FIG. 5 in an enlarged view for a sequence of steps for filling a cannula during a sampling procedure,

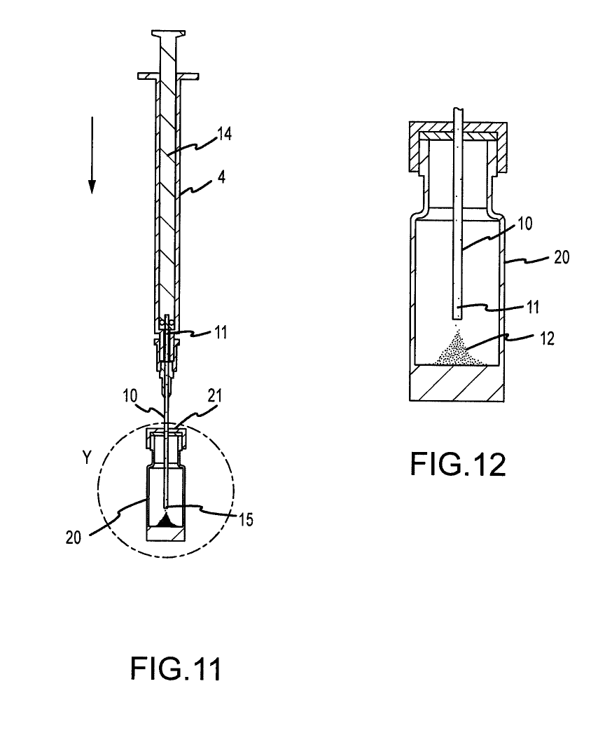

FIG. 11 shows, in cross section, a sample introduction into a vial with the sampler according to FIG. 5 and FIG. 6, and

FIG. 12 shows the detail Y from FIG. 11 in an enlarged view.

The invention relates to a device for the automatic sampling of samples for sample preparation or sample introduction for an analytical apparatus, in particular a chromatograph such as a gas chromatograph or liquid chromatograph, a mass spectrometer or the like.

FIG. 1 and FIG. 2 show such a device for handling samples, for example an autosampler. The device preferably comprises a horizontal carriage guide 1 for a cross slide 2, which is movable along the carriage guide 1 and is also preferably movable in the plane of the carriage guide 1 perpendicular to the carriage guide 1, such that all stations can be served. A holding arm 3, which is preferably vertically movable, is located at the end of the cross slide 2.

The movable holding arm 3 is configured to exchangeably hold at least one sampler 4, for which purpose, for example, a holder 5 is provided on the holding arm 3. The holding arm 3 is used to move the respective sampler 4 to a position above of a desired sample container 6. For this purpose, a number of sample containers 6 are placed on a sample tray 7. The sample containers 6 each contain a quantity 8 (cf. FIG. 5 to FIG. 10) of a granular solid material. The sample tray 7 with a selectable number of sample containers 6 can be placed on a panel 9 belonging to the device. The sample tray 7 can be adapted to individually configured sample containers 6. The holder 5 can be designed in a known manner, for example as described in DE 102 19 790 C1.

From the sample containers 6, a sample 12 is taken from the quantity 8 contained therein by means of the sampler 4, for which purpose the sampler 4 can be moved up and down. The movement is performed by the movable holding arm 3. The preferred direction of movement is a vertical movement of the sampler 4 for sampling.

As FIG. 3 and FIG. 4 show, the sampler 4 for sampling of granular material comprises a cannula 10 as a filling space. As FIG. 5 to FIG. 10 further show, a cannula plunger 11 is arranged displaceably in the cannula 10 for opening and emptying the filling space 13 of the cannula 10 that is to be filled with a sample 12 (cf. FIG. 7 to FIG. 10). The cannula plunger 11 is preferably engaged with a slider 14, with which the cannula plunger 11 can be displaced in the cannula 10. The advance range preferably extends between a lower position, in which the cannula plunger 11 reaches to the lower end 15 of the cannula 10 (cf. FIG. 4), and an upper position, which is defined by a selectable height of the filling space 13, up to which the cannula plunger 11 is drawn back from the lower end 15 of the cannula 10 to provide the filling space 13 for the sampling.

The cannula 10 of a sampler 4 thus has a lower end 15, which serves as a free end for introducing granular material into the filling space 13 of the cannula 10. For introducing granular material into the filling space 13 the cannula 10 is pushed repeatedly with the lower end 15 against the bottom 16 of the respective sample container 6 containing a granular material. The lower end 15 of the cannula 10 hits the bottom 16 of the respective sample cannula with a predetermined pressure, which can be set by means of a pressure limiter 17 associated with the sampler 4 or with the sample container 6. When the predetermined pressure is reached, a downward movement of the sampler 4 is stopped controlled by the pressure limiter 17. Consequently, a contact pressure of the lower end 15 against the bottom 16 is limited to the predetermined pressure. The movable holding arm 3 thus acts on the sampler 4 such that the cannula 10 provided on the latter performs an action pattern in the sample container 6 being carried out in a force-feeding manner, by which granular material is pressed upwards into the cannula 10 up to a selectable filling height. Thus, if the cannula 10 is pushed down to the bottom 16 into the sample container 6, which is filled in particular partially with a granular material, for example with a powder, then the granular material is at the same time pressed into the cannula 10.

The diameter of the cannula 10 is chosen such that the adhesion forces of the grains of the granular material to one another and to the inner wall of the cannula are greater than the forces of gravity, such that granular material introduced into the cannula 10 does not fall out, but can be dispensed only when the thrust of the cannula plunger 11 is applied. Customary internal diameters of the cannula lie in a range of 0.4 to 2.0 mm. The grain sizes of the granular material lie on average in the range of 10-500 μm.

The sampler 4 is preferably attached to a vertically displaceable holding arm 3 for performing a number of pushing impacts of the end 15 of the cannula 10 against the bottom 16 of the respective sample container 6. The pushing direction preferably coincides with the axis of a cannula 10, which then performs vertically directed pushing impacts as force-feeding or stuffing actions.

The pressure limiter 17 can comprise a force meter (not shown) which, during the introduction of granular material into the filling space 13 of the cannula 10, measures the pressing force executed on the lower end 15 of the cannula 10. The force meter can be integrated into the holder 5 as a force sensor.

According to the embodiment shown in FIG. 1 to FIG. 10, the pressure limiter 17 connected to the respective sample container 6 comprises a spring element 18. The spring element 18 provides a spring-loaded support for the sample container 6 in the direction of movement of the cannula 10 and controls the movement of the sample container 6. The spring element 18 is, for example, a coil spring whose spring axis is preferably aligned with the axis of the cannula 10 during the sampling procedure. The spring element 18 can, for each sample container 6, be placed in a socket 19 which is provided in the sample tray 7 in order to guide the resilience of the individual sample containers 6. The spring-loaded support of the sample containers 6 also compensates for length tolerances and ensures that the cannula 10 can reach down to the bottom 16. The filling of the cannula 10, during a sampling procedure from a sample container 6, preferably takes place in a deflected range of the spring element 18, wherein the depth of the spring deflection depends on the spring constant of the spring element 18 used. The maximum spring deflection is defined by the pressure limiter 17 and can be adjusted via the spring constant.

The bottom 16 of each sample container 6 is preferably provided with a recess or a hollow cone shape, whereby a deep-lying collecting point for granular material is obtained in the sample container 6. Taking up small quantities of granular material is facilitated in this way. The lower end 15 of a cannula can be provided with a cutting edge, whereby the sampling by means of the cannula 10 can be combined with a crushing of the grains of the granular material.

As FIG. 7 to FIG. 10 show, the cannula 10 is pushed several times against the bottom 16 of the sample container 6 for sampling, in this case three times. If the process is repeated several times, the cannula 10 is filled ever higher, since the granular material clings inside the cannula 10. As FIG. 10 shows, the cannula plunger 11 defines, by its position in the cannula 10, the height of penetration of the granular material. The sample 12 then corresponds to the quantity that can be introduced into the filling space 13. The cannula plunger 11 ensures that the filling level cannot exceed a defined height. If the friction between the granular material and the inner wall of the cannula 10 becomes too great, the discharge of the accumulated granular material in the cannula 10 is impeded or in some cases is no longer possible at all. The filling level also allows the taken-up material to be precisely dosed in the cannula 10. In addition, the dosing unit in the form of a cannula 10 is a disposable item. The cannula plunger 11 can be a wire, for example.

The sample container 6 containing a granular material can be closed with a septum, since the cannula 10 can pierce such a septum. In this case, the cannula plunger 11 is preferably lowered and closes the lower end of the cannula 10. In this way, no piece of the septum can enter the cannula during the piercing. After the penetration, the cannula plunger 11 can be lifted in a controlled manner to make room for the granular material by creating a filling space 13. By moving the cannula up and down as described above, the sample 12 is collected from the quantity 8 of the granular material.

As FIG. 11 and FIG. 12 show, the sample 12 collected by the sampler 4 and by the cannula 10 of the latter can be dispensed into a vial 20 to be charged with a sample. This is done by pushing down the cannula plunger 11. The dispensing of the sample 12 can be tied to a weighing-in procedure, since the actuation of the cannula plunger 11 permits a quantity control. The cannula 10 can be designed such that its lower end 15 can pierce a septum 21 with which the vial 20 is to be closed. The cannula 10 can also be used to introduce solvents in the context of a sample preparation.

The cannula 10 can moreover be fitted on a syringe body, such that the cannula plunger 11 can then be connected to a slider 14 being a syringe plunger, as is illustrated in particular in FIG. 5, FIG. 6 and FIG. 11. In known autosamplers that comprise holders 5 for holding syringe bodies, the samplers 4 according to the invention can be installed without any modification measures. The sampler 4 can then be mounted like a liquid syringe. Syringe changers can then likewise be used. Existing automation components can be used in full.

According to an embodiment not shown, the sample container 6 can be exposed to a vibration or shaking movement in order to move the granular material with preferably small, rapid jolts. Hereby the granular material is supported in sliding down to the bottom of the sample container 6.

All publications and patent applications mentioned in this specification are herein incorporated by reference to the same extent as if each individual publication or patent application was specifically and individually indicated to be incorporated by reference.

The invention now being fully described, it will be apparent to one of ordinary skill in the art that many changes and modifications can be made thereto without departing from the spirit or scope of the appended claims.

1. Device for automatic sampling of samples for sample preparation or sample introduction for an analycal apparatus, in particular a chromatograph, with a movable holding arm for exchangeably holding at least one sampler, and with sample containers, from each of which a sample can be taken by means of a sampler that can be moved up and down, wherein, for taking up a sample of granular material, the sampler comprises a cannula as a filling space, in which a cannula plunger is displaceably arranged for opening and emptying the filling space of the cannula that is to be filled with a sample, and the cannula comprises a free lower end which, in order to introduce granular material into the filling space of the cannula, is repeatedly pushed against the bottom of the respective sample container, containing a quantity of granular material, using a predetermined pressure, which can be set by means of a pressure limiter associated with the sampler or with the sample container.

2. Device according to claim 1, wherein the sampler is attached to a vertically displaceable holding arm.

3. Device according to claim 1, wherein the lower end of the cannula is pulsatory pushed against the bottom of a sample container.

4. Device according to claim 1, wherein the pressure limiter comprises a force meter, which measures a pressing force executed on the lower end of the cannula, which force can be executed to introduce granular material into the filling space of the cannula.

5. Device according to claim 1, wherein the pressure limiter associated with the respective sample container comprises a spring element for a spring-loaded support of the sample container in the direction of movement of the cannula and for controlling the movement of the sample container.

6. Device according to claim 5, wherein the spring element is a coil spring whose spring axis is aligned with an axis of the cannula during the sampling procedure.

7. Device according to claim 1, wherein the bottom of the sample container is provided with a recess.

8. Device according to claim 1, wherein the sample container can be exposed to a vibration or shaking movement.
